(19) United States
(12) Patent Application Publication
(10) Pub. No.: US 2005/0056386 A1
(43) Pub. Date: Mar. 17, 2005

(54) Folding closure with equally sized panels

(76) Inventor: Craig Frederick Hicks, Ashgrove (AU)

Correspondence Address: WELLS ST. JOHN P.S., 601 W. FIRST AVENUE, SUITE 1300, SPOKANE, WA, 99201, US

(21) Appl. No.: 10/913,279

(22) Filed: Aug. 5, 2004

(30) Foreign Application Priority Data
Aug. 6, 2003 (AU) 2003904120

(51) Int. Cl. E05D 15/26

(52) U.S. Cl. 160/199

(57) ABSTRACT

A folding closure (20), such as a bifold door or window, comprises at least three hinged panels (21, 21, 23, 24) suspended from the track. The panels can be folded about their hinged connections, from a closed configuration whereat they are aligned substantially in a plane, to an open configuration whereat they are juxtaposed in substantially parallel planes orthogonal to the plane. An end panel (21) is hinged to a jamb by an offset hinge (25). At least one pair of adjacent panels (21, 23 and/or 22, 24) are hinged together by at least one offset hinge (30, 31), to compensate for the offset of the end panel (21), and thereby permit all the panels to be of substantially equal width.

### TECHNICAL FIELD

This invention relates to a folding closure, such as a folding door or window, having a plurality of hinged panels, all of which are of substantially the same width. In particular, the invention is directed to a folding door or window comprising at least three hinged panels of equal width, of which at least two panels are joined by offset hinges.

### BACKGROUND OF THE INVENTION

Folding doors and windows are a popular building choice, due to their ability to provide clear unimpeded openings in a wall. A typical folding door or window comprises a plurality of hinged panels suspended from one or more carriages which travel along an overhead track. A carriage and a hinge may be combined to form a carrier hinge in which the hinge pin serves to suspend the hinge (and affixed panels) from the carriage, as shown in U.S. Pat. No. 6,618,900.

The panels may open by folding, in concertina fashion, to one side of the opening. Alternatively, particularly for wide openings, the panels may be formed as two hinged sets which fold to opposite sides of the opening. In both cases, the panels fold open to an orientation in which they are juxtaposed parallel to each other, 90° to the plane of the opening, to minimise the width of the opening they occupy.

A plan view of a conventional folding door or window 10 is shown schematically in FIG. 1. The illustrated closure comprises an end or jamb panel “A” which is adjacent the jamb 15 and hinged thereto by a single-leaf hinge 11, a leading panel “B” which is furthest from the jamb, and a pair of intermediate panels “C”, “D” which are hinged to the jamb and leading panels, respectively, typically by upper and lower butt hinges 12 edge-fixed to those panels. The two intermediate panels C, D are also hinged together by upper and lower edge-fixed butt hinges (not shown), the upper hinge being suspended from a carriage 13. The distal end of the leading panel B is suspended from the track by a single-leaf carrier hinge 14.

To ensure that the proximal end face of the jamb panel A closes sufficiently close to the jamb face 15 to provide adequate weatherproofing, the jamb panel A is hinged to the jamb 15 by upper and lower offset hinges 11 each having a single angled leaf, i.e. the mounting face of each hinge leaf is offset from its hinge axis. Similarly, to ensure that the distal end face of the leading panel B closes sufficiently close to the opposite jamb, or an opposing leading panel, to provide adequate weatherproofing, the leading panel B is hinged to the carriage 14 by at least an upper offset hinge having a single angled leaf.

Consequently, as can be seen in FIG. 1, the jamb and leading panels A, B have a width “W” which is greater than the width of the intermediate panels C, D by an amount “w”, being the hinge offset. An inherent disadvantage of such folding doors and windows is that the panels must be manufactured in two different sizes. This adds significantly to manufacturing and inventory costs. Furthermore, errors may occur in installation due to the wrong sized panel being mounted in the wrong position.

U.S. Pat. No. 4,295,514 discloses a bifold door assembly comprising two door panels of equal width. The panels are joined by hinges having knuckles offset from the panel edges, to permit the door panels to be opened to an obtuse position, i.e. greater than 90°. However, while this may be an advantage for a small two panel bifold cupboard door, it is not applicable to most large doors and windows having three or more panels as the jambs of such doors and windows do not normally permit the panels to open to an obtuse orientation, nor is it usually desired to fold the panels open to an obtuse orientation.

Moreover, the hinge arrangement of the '514 patent is unsuitable for conventional folding closures of three or more hinged panels for several reasons. First, as can be seen from FIG. 5 of the '514 patent, the panels cannot be arranged parallel to each other and at 90° to the plane of the opening. If the end panel is folded against a jamb at 90° to the plane of the opening, the adjacent panel will be angled obliquely, which not only occupies more of the opening space, but also detracts from the aesthetic appearance of the folded panels.

Secondly, if a third panel were to be added to the embodiment shown in FIG. 5 of the '514, say for a wider opening, the axis of the hinge connection of that third panel to its adjacent panel would not follow the guide track, and hence a carrier hinge could not be used.

Thirdly, the hinge arrangement of the '514 patent is designed for bifold doors having pivots and guides within the perimeter or plan section of the door, unlike many suspended folding doors in which the hinge axis (or axes) of each panel is (or are) located outside the plan section of the panel.

It is an aim of this invention to provide an improved folding closure with panels of equal width, which overcomes or ameliorates one or more of the disadvantages or problems described above.

### SUMMARY OF THE INVENTION

In one broad form, this invention provides a folding closure comprising an overhead track, and at least three hinged upright panels of substantially equal width suspended from the track. The panels are adapted to be folded about their hinged connections from (a) a closed configuration whereat they are aligned substantially in a plane to (b) an open configuration whereat they are juxtaposed in substantially parallel planes orthogonal to the plane. At least one pair of adjacent panels of the closure are hinged together by at least one offset hinge.

Where the context permits, the term “offset hinge” as used herein is intended to mean a hinge having one or more leaves each adapted to be fixed to a respective panel, the plane of the fixing face of each leaf being offset from the hinge axis.

The closure is typically a door or window, but could be a screen, shutter, partition or the like. The term “panel” as used herein is intended to include any generally planar component of a folding door, window, screen, partition or the like, whether glazed or unglazed. The invention has particular application to an external folding door or window of a building, but is not limited thereto, as it can also be applied to internal partitions.

Normally, a first or end panel of the closure is hinged to a jamb member by at least another (single leaf) offset hinge. The use of the offset hinge between at least a pair of adjacent panels compensates for the offset introduced by the end panel, and enables panels of equal width to be used in the folding closure.

Preferably, each offset hinge which is connected between a pair of adjacent panels is a double-leaf non-mortise offset hinge in which one leaf fits within the other. Each such offset hinge is suitably edge-fixed to the pair of adjacent panels, i.e. fixed to opposed end faces of the panels by screws or other fasteners. However, the offset hinge may alternatively be face-fixed to the pair of adjacent panels, i.e. fixed to a side of each panel.

Typically, the pair of adjacent panels are hinged together by two offset hinges located respectively near the top and bottom of the panels. A third offset hinge may be connected to the pair of adjacent panels between the two offset hinges. The third offset hinge may be provided with a handle.

Normally, each of the panels is mounted for pivoting about an axis or axes outside the respective panel.

Preferably, the folding closure includes at least one carriage adapted to travel along the track. A pair of adjacent panels of the folding closure can be joined by a hinge which is connected to the carriage and suspended therefrom. (This may be the pair of adjacent panels connected by the offset hinge(s), or another pair).

In another form, the invention provides a method of forming a folding closure, comprising the steps of: suspending at least three hinged panels of substantially equal width from a track, such that the hinged panels can be folded from (a) a closed configuration whereat they are aligned substantially in a plane to (b) an open configuration whereat they are juxtaposed in substantially parallel planes orthogonal to the plane; and joining at least one pair of adjacent panels of the closure by at least one offset hinge.

In yet another form, the invention provides a folding closure for an opening in a building, comprising at least three hinged panels of equal width, the panels being adapted to be folded about their hinged connections from (a) a closed configuration whereat they are aligned substantially in a plane to (b) an open configuration whereat they are juxtaposed in substantially parallel planes orthogonal to the plane, and wherein at least one pair of adjacent panels are hinged together by at least one offset hinge.

In order that the invention may be more readily understood and put into practice, preferred embodiments thereof will now be described, by way of example only, with reference to the accompanying drawings.

### BRIEF DESCRIPTION OF THE DRAWINGS

Preferred embodiments of the invention are described below with reference to the following accompanying drawings.

FIG. 1 is a plan view of a prior art folding closure.

FIG. 2 is a plan view of a folding closure according to one embodiment of the invention.

FIG. 3 is a plan view of the folding closure of FIG. 2 with top mount and carriages removed to show the hinges.

FIG. 4 is a perspective view of the folding closure of FIG. 2 (when open).

FIG. 5 is a perspective view of an offset hinge in one configuration.

FIG. 6 is a perspective view of the offset hinge of FIG. 5 in another configuration.

FIG. 7 is a perspective view of an offset hinge with handle attached.

FIG. 8 is a plan view of a folding closure (when open) according to a second embodiment of the invention.

FIG. 9 is a plan view of the folding closure FIG. 8, with carriage omitted.

FIG. 10 is a plan view of the folding closure of FIG. 8, when closed.

FIG. 11 is a plan view of the folding closure of FIG. 10 with carriage omitted.

FIG. 12 is a plan view of a folding closure according to a third embodiment of the invention.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

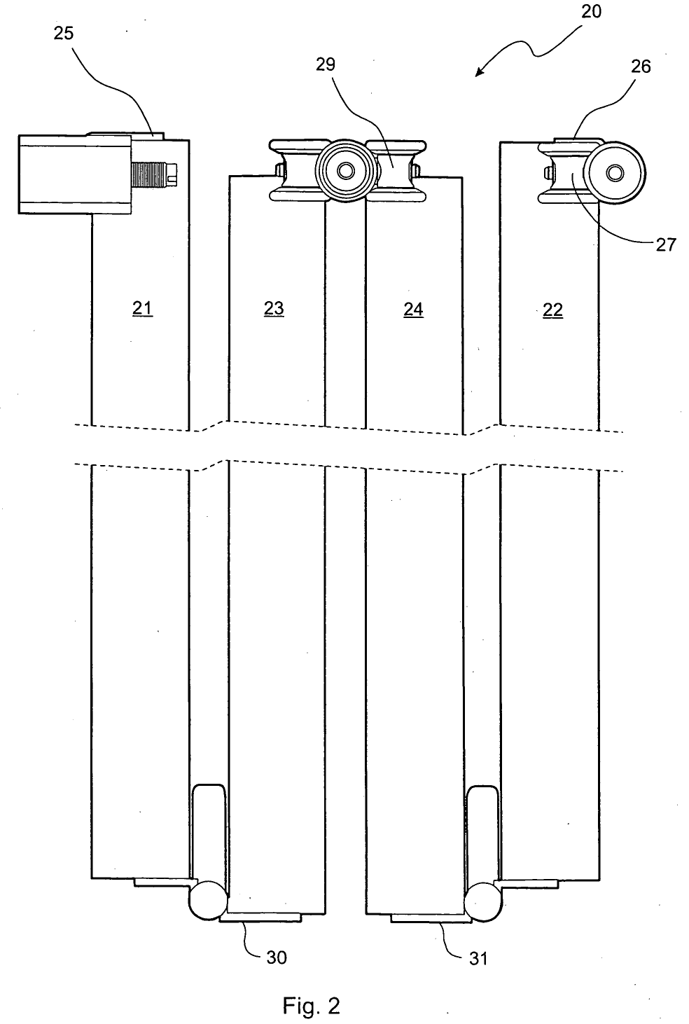

As shown in FIGS. 2 to 4, a folding closure 20, which may be a folding door or window, comprises four hinged panels 21-24. A jamb panel 21 is hinged to a jamb (not shown) by top and bottom single-leaf offset hinges 25, as is known in the art. A leading panel 22 is suspended from a carriage 27 by a single-leaf offset hinge 26, again as is known in the art. Two intermediate panels 23, 24 are hinged together at one end thereof by top and bottom edge-fixed butt hinges 28, the upper hinge being suspended from a carriage 29, as is known in the art. It is to be noted that the hinge axes of hinges 25, 26, 28 are aligned with the centreline 19 of the track (not shown) on which the carriages 26, 29 travel. Thus the carriages 26, 29 can form part of respective carrier hinges.

At its other end, intermediate panel 23 is hinged to the jamb panel 21 by top and bottom double-leaf offset hinges 30. Similarly, at its other end, intermediate panel 24 is hinged to the leading panel 22 by top and bottom double-leaf offset hinges 31.

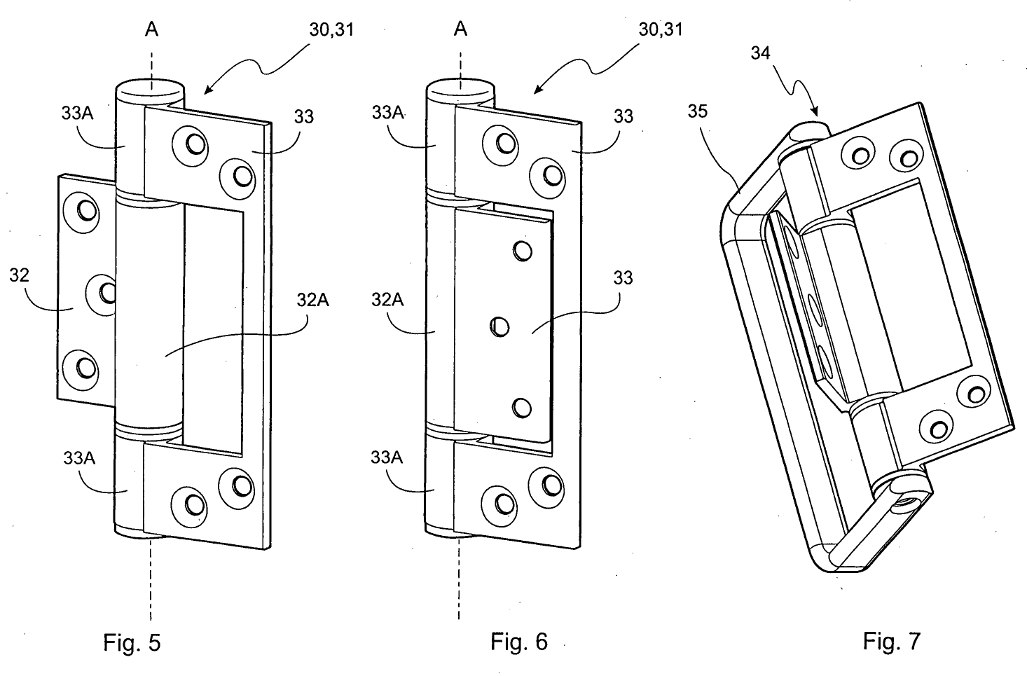

The construction of the offset hinges 30, 31 is shown in more detail in FIGS. 5 and 6. FIG. 5 shows the hinge with its hinge leaves at 180° (which is the configuration of the hinge when the panels are folded to an open position as shown in FIGS. 2-4). FIG. 6 illustrates the hinge with its hinge leaves at 0° (which is the configuration of the hinge when the panels have been extended to a closed position). At this configuration, the leaves interfold into the thickness of a single leaf, i.e. the hinge is a non-mortise hinge.

As shown in FIGS. 5 and 6, each hinge 30, 31 has a pair of interfolding or interfitting leaves 32, 33 adapted to be screwed to an edge face of a respective one of a pair of adjacent panels. Each leaf 32, 33 has a knuckle portion 32A, 33A, respectively with a bore through it. A hinge pin (not shown) is located within the aligned bores, and defines a hinge axis A about which the hinge leaves 32, 33 can pivot.

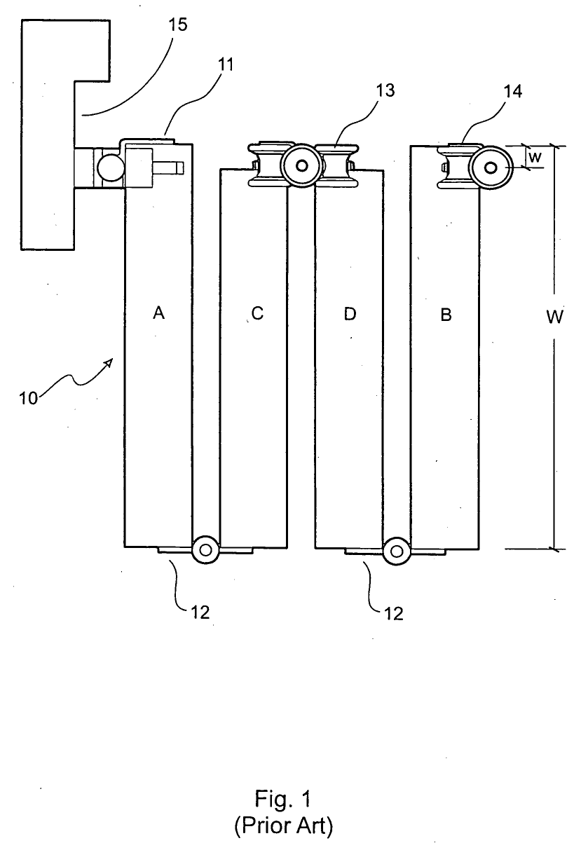

However, unlike the known regular butt hinges 12 used between adjacent panels on conventional folding closures as shown in FIG. 1, the hinge leaves 32, 33 are substantially offset from the hinge axis A. That is, the hinge axis A is offset or spaced from the plane defined by the face of each hinge leaf 32, 33 which is fixed to the panel.

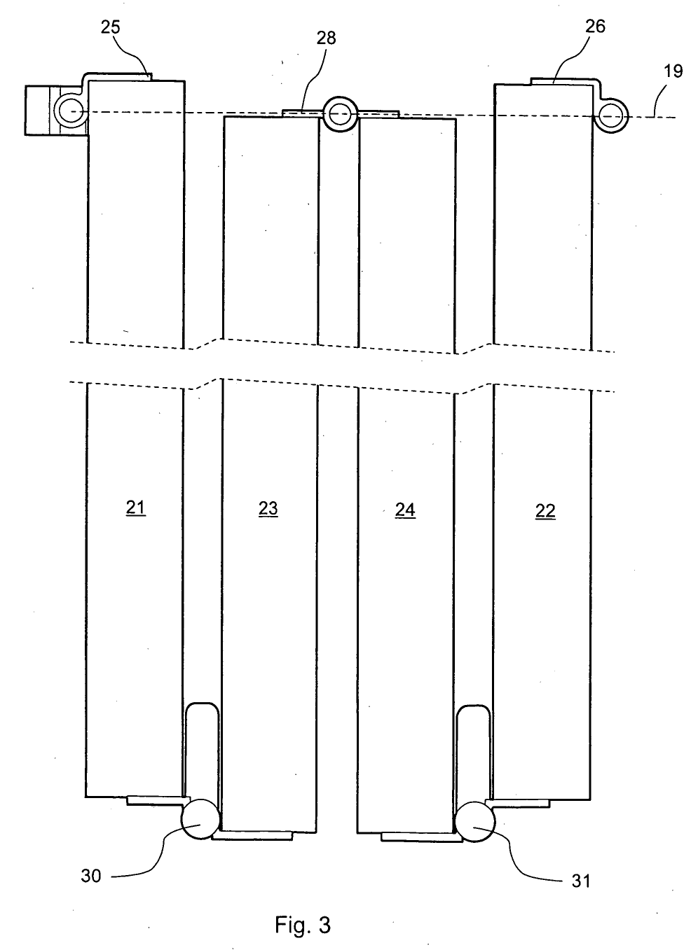

The total offset distance, i.e. the transverse spacing between the fixing faces of the hinge leaves when they are at 180°, is selected to counter the offset of the single-leaf offset hinges used on the jamb and leading panels. In this manner, all panels 21-24 can be made of the same width and still have their carriages aligned on the track, as can be seen clearly in FIG. 3. Consequently, manufacturing can be standardised and inventory can be reduced, thereby reducing overall costs of manufacture.

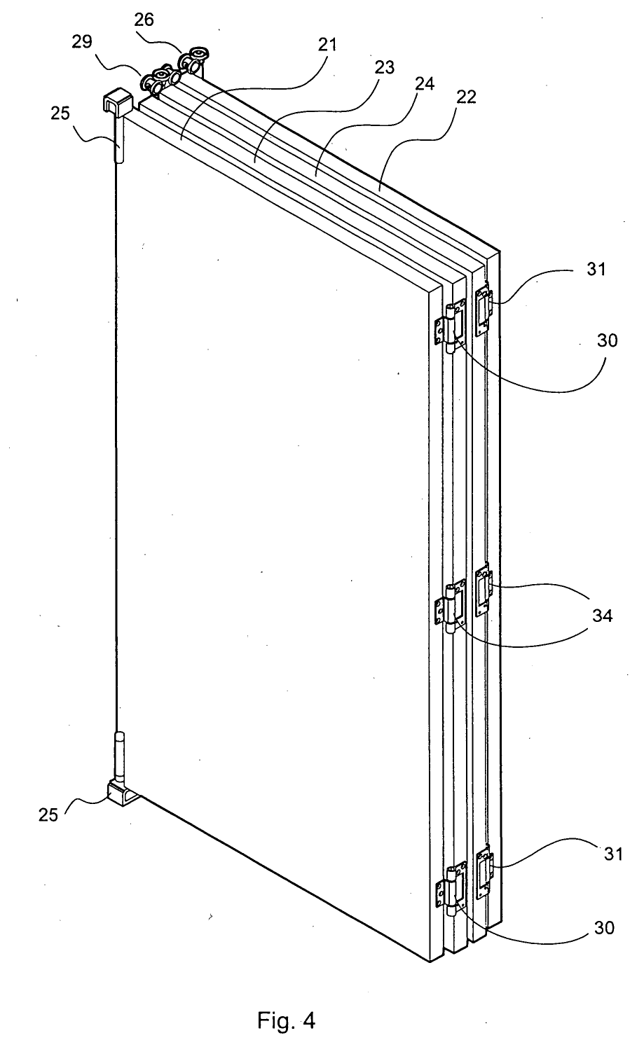

For tall panels, such as door panels, intermediate offset dual-leaf hinges 34 may be fixed to adjacent panels between the top and bottom hinges, as shown in FIG. 4. The construction of each intermediate offset hinge 34 is shown in more detail in FIG. 7. The intermediate hinge 34 is of similar construction to the top and bottom offset hinges 30, 31, but is provided with a handle 35 to facilitate folding of the panels from their flat (closed) configuration.

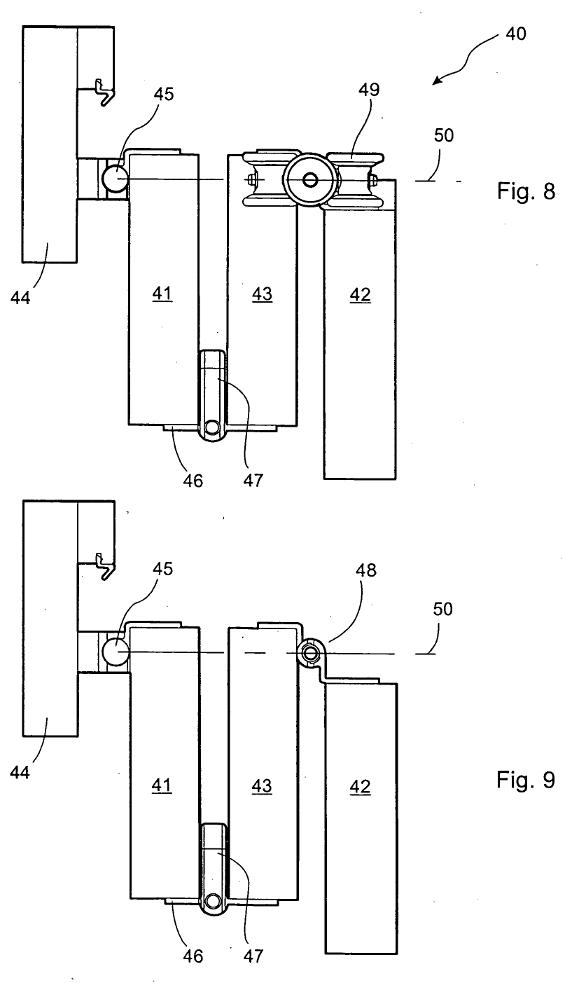

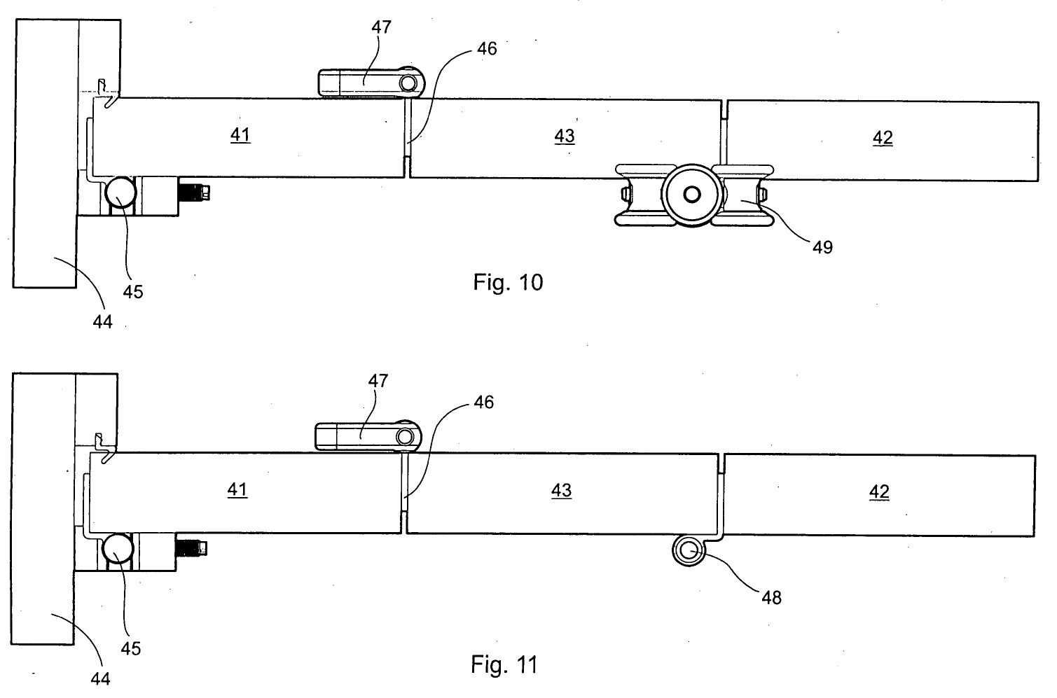

The advantages of the invention can also be obtained by using different positioning of the offset hinges. FIGS. 8-11 illustrate another embodiment of the invention. In this three-panel embodiment, a folding closure 40 comprises a jamb panel 41, a leading panel 42 and an intermediate panel 43. The jamb panel 41 is connected to the jamb 44 by a single leaf offset hinge 45. The jamb panel 41 is also hinged to the intermediate panel 43 by top and bottom regular (flat leaf) butt hinges 46, each having a leaf edge-mounted to the respective panel. For tall panels, such as in a folding door, an intermediate hinge with a handle 47 may also be provided.

The intermediate panel 43 is also hinged to the leading panel 42, but by top and bottom dual-leaf offset hinges 48, the top hinge 48 being suspended from a carriage 49. In this embodiment, the leaf of hinge 48 which is fixed to the intermediate panel 43 should have the same amount of offset as that of hinge 45. This enables all of the panels 41-43 of the embodiment of FIGS. 8-11 to be of the same width, yet the axis of hinge 48 still aligns with the track line 50, enabling the hinge 48, and carriage 49 to be combined as a carrier hinge.

The principal advantage of the invention, i.e. a folding closure with panels of equal width, can also be achieved by replacing each hinge 48 with a regular butt hinge, and each hinge 46 with an offset hinge having the appropriate amount of offset. That is, the jamb panel 41 and the intermediate panel 43 can be hinged together using top and bottom offset hinges, while the intermediate panel 43 and the leading panel 42 can be hinged together using top and bottom flat leaf butt hinges.

In another variation, hinges 46 and 48 of the embodiment of FIGS. 8-11 can be replaced by two offset hinges, each of appropriate offset, so that the axis of hinge 48 remains aligned with track line 50.

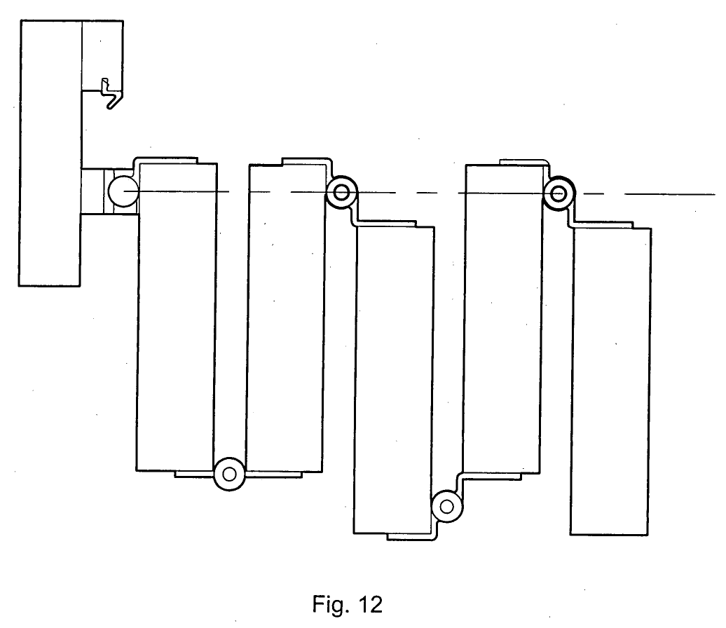

In yet another embodiment, a folding closure with panels of equal width can be obtained by replacing each hinge 30 of the embodiment of FIGS. 2-4 with a regular butt hinge, and fixing offset hinges between panels 23 and 24, and between 24 and 22, as shown applied to a five panel closure in FIG. 12. In this case however, the offset hinges will have twice the amount of offset of the offset hinges of FIGS. 2-4.

The foregoing embodiments are illustrative only of the principles of the invention, and various modifications and changes will readily occur to those skilled in the art. For example, although the illustrated embodiments use edge-fixed hinges, the invention can also utilise face-fixed offset hinges.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A folding closure comprising:
an overhead track,
at least three hinged upright panels of substantially equal width suspended from the track, the panels being adapted to be folded about their hinged connections from (a) a closed configuration whereat they are aligned substantially in a plane to (b) an open configuration whereat they are juxtaposed in substantially parallel planes orthogonal to the plane, and
at least one offset hinge,
wherein at least one pair of adjacent panels of the closure are hinged together by said at least one offset hinge.

2. A folding closure as claimed in claim 1, wherein each of the panels is mounted for pivoting about an axis or axes outside the respective panel.

3. A folding closure as claimed in claim 1, wherein said at least one offset hinge is a double-leaf non-mortise offset hinge in which one leaf fits within the other.

4. A folding closure as claimed in claim 1, wherein said at least one offset hinge is edge-fixed to the pair of adjacent panels.

5. A folding closure as claimed in claim 1, wherein said at least one offset hinge is face-fixed to the pair of adjacent panels.

6. A folding closure as claimed in claim 1, wherein said pair of adjacent panels are hinged together by two offset hinges located respectively near the top and bottom of the panels, further comprising a third offset hinge connected to said pair of adjacent panels between the two offset hinges, the third offset hinge having a handle connected thereto.

7. A folding closure as claimed in claim 1, wherein one of the hinged panels is an end panel which is hinged to a jamb member by at least one other offset hinge.

8. A folding closure as claimed in claim 1, further comprising at least one carriage adapted to travel along the track, and wherein a pair of adjacent panels of the folding closure are joined by a hinge which is connected to the carriage and suspended therefrom.

9. A folding closure as claimed in claim 1, wherein the closure is an external door or window of a building.

10. A method of forming a folding closure, comprising the steps of:
suspending at least three hinged panels of substantially equal width from a track, such that the hinged panels are adapted to be folded from (a) a closed configuration whereat they are aligned substantially in a plane to (b) an open configuration whereat they are juxtaposed in substantially parallel planes orthogonal to the plane, and
joining at least one pair of adjacent panels of the closure together by at least one offset hinge.

11. A folding closure for an opening in a building, comprising at least three hinged panels of equal width, the panels being adapted to be folded about their hinged connections from (a) a closed configuration whereat they are aligned substantially in a plane to (b) an open configuration whereat they are juxtaposed in substantially parallel planes orthogonal to the plane,
wherein at least one pair of adjacent panels are hinged together by at least one offset hinge.

12. A folding closure as claimed in claim 11, wherein said at least one offset hinge is a double-leaf non-mortise offset hinge in which one leaf fits within the other.

13. A folding closure as claimed in claim 12, wherein said at least one offset hinge is edge-fixed to the pair of adjacent panels.

14. A folding closure as claimed in claim 11, wherein one of said panels is an end panel having at least one single-leaf offset hinge thereon for hinged connection to a jamb member.

15. A folding closure as claimed in claim 11, wherein each of the panels is mounted for pivoting about an axis or axes outside the respective panel.

16. A folding closure as claimed in claim 11, further comprising:
an overhead track, and
at least one carriage adapted to travel along the track,
wherein a pair of adjacent panels of the folding closure are joined by a hinge which is connected to the carriage and suspended therefrom.
